(19) United States
(12) Patent Application Publication
(10) Pub. No.: US 2006/0241911 A1
(43) Pub. Date: Oct. 26, 2006

(54) Systems and methods for aggregating telephony and internet data

(76) Inventors: Kian Fai Leong, Singapore (SG); Joseph Park, Redmond, WA (US); Jason Liu, Iselin, NJ (US)

Correspondence Address: Mr. Kian Fai Leong;#2190, 1263 Lakeside Dr., Sunnyvale, CA, 94085, US

(21) Appl. No.: 11/110,212

(22) Filed: Apr. 20, 2005

(51) Int. Cl. G06F 15/00

(52) U.S. Cl. 702/186

(57) ABSTRACT

Teleranking is the aggregation and analysis of customer call and click data through any communication device (“Device”) that provides relevancy and rankings of a Target(s) that is being searched for by the user. The Target can be a location(s), a business(es), a person(s) or a website(s). By combining call and click data with database information pertaining to the Target(s), Teleranking can deliver ranked relevancy for the Target(s) based on weight-based algorithms. When a user searches for a Target(s) on their Device, the call and click data assigned to each Target(s) is logged into a database. Based on the call and click characteristics and the user profile, a certain weight(s) is assigned to the Target(s). The weight(s) assigned determines the popularity and relevancy of the Target(s) based on the aggregate call and click data and the location and profile of the Device user. The Device User's Information is defined as the profile of the Device user, the actions and/or events generated by the Device or the Device User.

### CROSS REFERENCE TO RELATED APPLICATION

Not Applicable.

### STATEMENT REGARDING FEDERALLY SPONSORED RESEARCH AND DEVLOPMENT

Not Applicable.

### INCORPORATION-BY-REFERENCE OF MATERIAL SUBMITTED ON A COMPACT DISC

Not Applicable.

### BACKGROUND OF THE INVENTION

(1) Field

The disclosed methods and systems relate generally to aggregating data, and more particularly to aggregating, filtering, and querying cellular telephone and internet selection data.

(2) Description of Relevant Art

Web search engines crawl through the web and index information. Consequently, web search engines can only provide users with relevant search results for businesses with a website. For the millions of businesses without a website, web search engines will not have a website to crawl or index and therefore these businesses will not appear on web search results. As a result, consumers are not able to access millions of businesses via the Internet.

### SUMMARY OF THE INVENTION

The disclosed methods and systems provide consumers with access to businesses with or without a website. The disclosed methods and systems aggregate, weight, and rank user call and click data to provide relevancy and rankings of a Target(s) (i.e., a commercial or other entity) for each user. This information can be received through the Internet, wireline, and/or mobile phone network. Because a Target(s) only needs to be associated with a telephone number and/or website, users are able to receive relevant rankings of Targets regardless of whether the Target(s) has a website.

The weighting can determine the relevancy of the Target(s) to a user. For example, a popular restaurant will usually be a restaurant that receives a large number of calls. A server/computer can track the most frequently called restaurant(s) and present such results to a user. In this case, relevancy is based on call volume.

Furthermore, the weighting algorithm may also be based on historical call and other user input data. For example, a popular restaurant may cater to younger consumers aged 15-30. Therefore, a 50-year-old user searching for a restaurant may not be presented with this restaurant as it is deemed most likely to be less relevant. Therefore, besides demographics, other user input data and user information can be associated with and/or matched to similar user data, providing increased relevancy. The disclosed methods and systems can thus couple profile data (e.g., age, gender, income, geography, etc.) with aggregated call data to facilitate a search for a Target(s) that may be considered more relevant, based on the profile of the user to which the search results are presented.

Further disclosed are methods and systems that include a server that can collect (e.g., via telephony, cellular, VoIP, or Internet) “click data” and call data from a device that is associated with client software/instructions or a networked server, and store the data into a database. The methods and systems can determine relevancy of a “Target(s)” based on weights associated with the Target, a location and profile of a device/device user, and/or keywords or information searched.

Accordingly, the disclosed methods and systems include a collecting of event data from a device, where event data can be selections of telephone numbers, website selections, requests for driving instructions, event-driven activities (e.g., auto-generated queries based on selectable criteria), etc., where such information can be collected from the device (e.g., an application residing on and/or in communication with the device), and/or from another source such as a web browser, service provider (internet, cellular, etc.). The event data can be associated with a Target such that the event data can cause a modification of weights which are also associated with the Target. In some embodiments, the modification of weights can be based on user profile information. Accordingly, a Target can be associated with Target attributes (e.g., age, income, gender, etc.), and such target attributes can further be subdivided in categories (e.g., ranges of age, ranges of income, etc.). In such embodiments, each category of each attribute can be associated with a weight. In embodiments where user profile data/information may not be used and/or available, weight adjustment can be performed without consideration for profile information (e.g., a Target may be associated with a single weight that is not based on attributes). Such weights are understood herein to be indicative of relevancy rankings.

The disclosed methods and systems further associate a Target(s) with one or more keywords. Accordingly, based on a request for information that uses one or more keywords, one or more Targets can be identified. Further, based on the weights (i.e., relevancy rankings) of the identified Targets, a query response can be generated and provided to the device/user, where such response can rank the identified Targets based on relevancy. Such relevancy rankings can further be based on profile information from the user, such that the relevancy rankings are based on weights from attribute categories that are associated with the user's profile and/or otherwise designated by the user.

Other objects and advantages will become apparent hereinafter in view of the specification and drawings.

### BRIEF DESCRIPTION OF THE DRAWINGS

FIG. 1 is a diagram that illustrates the environment in which the invention can be implemented.

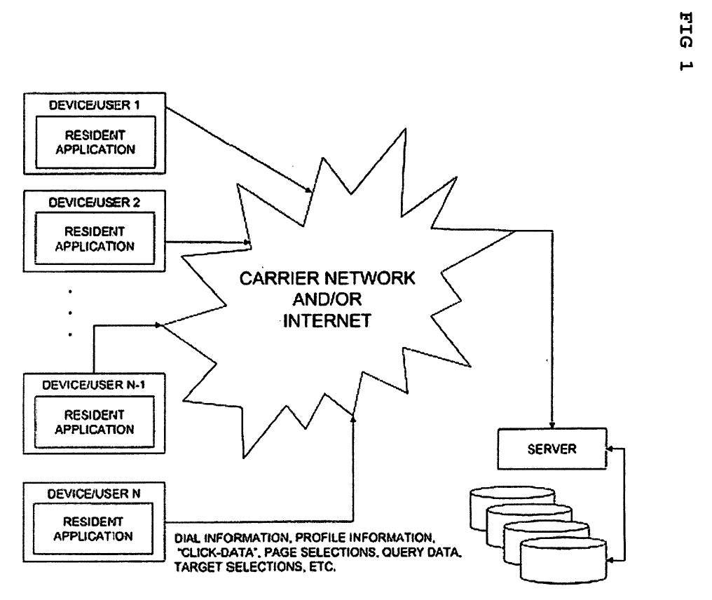

FIG. 2 is a diagram that illustrates the environment in which the invention can be implemented and where relevant targets are delivered to device or user.

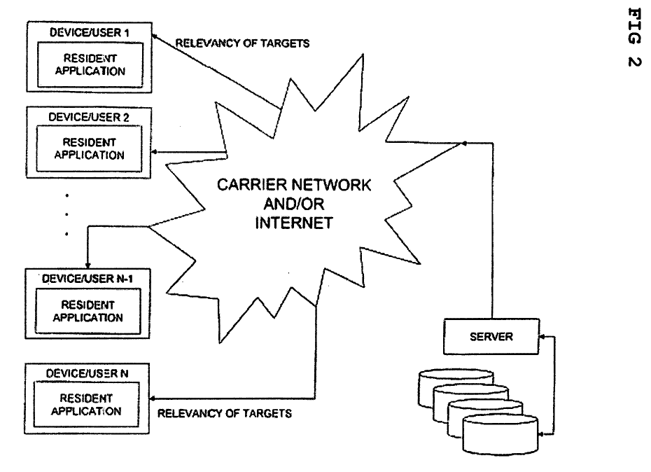

FIG. 3 is a flow diagram that illustrates the user of call data and caller profile to lookup relevant matrix for the target.

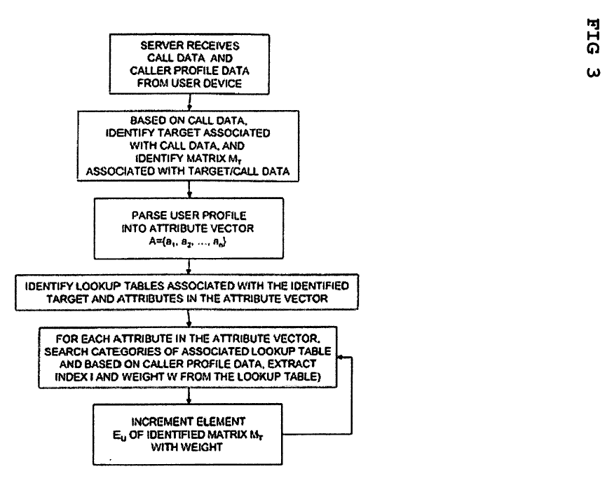

FIG. 4 is another flow diagram that shows the computation of relevant results for user and matrix.

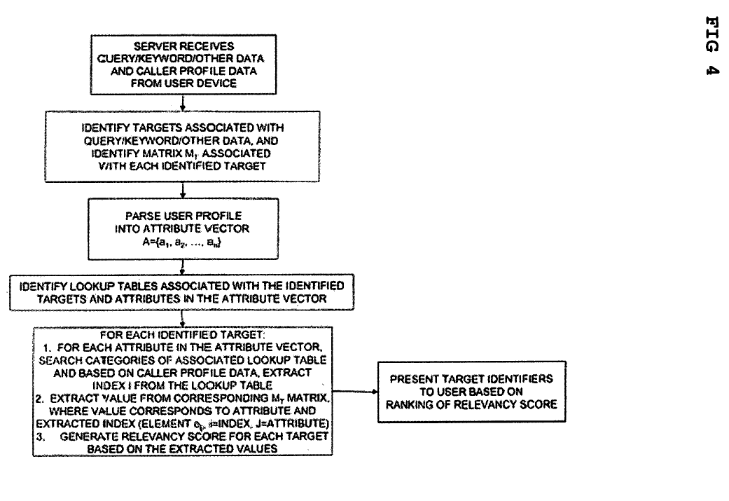

FIG. 5 is a diagram that illustrates the environment and architecture in which the invention can be implemented.

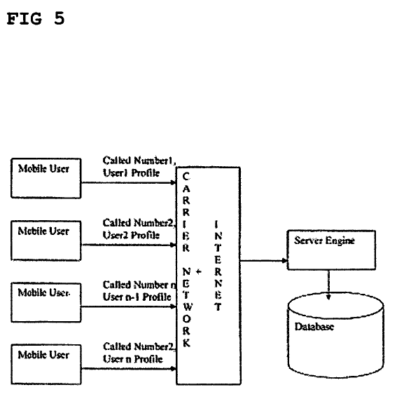

FIG. 6 is a flow diagram that illustrates how the weightage for a caller is derived.

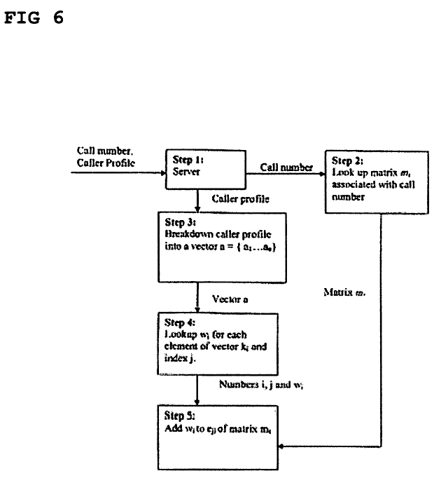

FIG. 7 is a flow diagram that illustrates how the combination of keyword and caller profile is used to calculate relevancy.

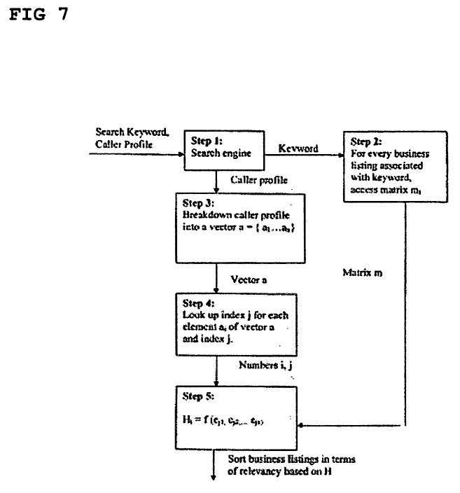

FIG. 8 is a flow diagram that illustrates the detection of the location of caller.

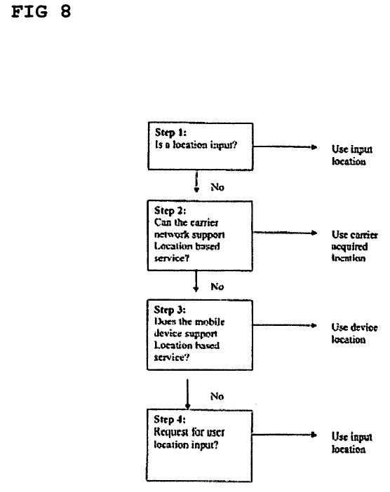

FIG. 9 is a diagram that illustrates how a lookup table is used to derive the weights for a specific category.

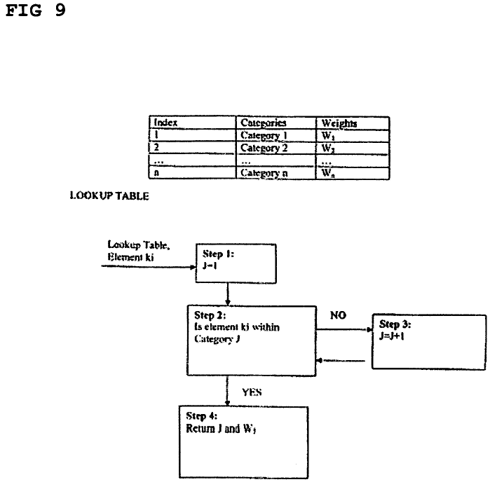

FIG. 10 is a diagram that illustrates how differenct page links are assigned different weights.

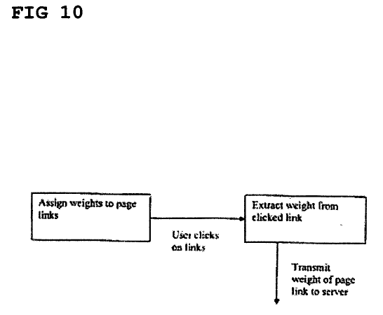

### DETAILED DESCRIPTION OF THE INVENTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the scope of the disclosed and exemplary systems or methods of the present disclosure.

The disclosed methods and systems related to a presentation of information to user's of a “device.” The “device” can be a processor-controlled device such as a cellular telephone, PDA, or other device that is capable of accessing a wired and/or wireless telecommunications network, and/or other networks such as, for example, the Internet. For the present disclosure, a “Target” can be understood to be an entity that can receive a telephone call, has a website, and/or is otherwise associated with a telephone number and/or a website. User's of the device can thus use the device to access the Targets via the Targets' telephone numbers, which may be available via the device. The disclosed methods and systems thus contemplate an application residing on the device which can facilitate the operation of the device as otherwise disclosed herein; however, in some embodiments, the “resident application,” as referred to herein, may not reside on individual user devices, but may reside on another device (e.g., server, device, etc.) that may in communication with the user device. Accordingly, references herein to “resident application” can be understood to be references to one example embodiment that is illustrated, with the understanding that other embodiments that are not illustrated, exist and are within the scope of the disclosed methods and systems. Additionally, as provided herein, other schemes for collecting data (e.g., web browser) may be used in addition to, and/or as an alternative to, an application, and accordingly, references herein to “resident application” can also be understood to include such other methods of collecting data regarding actions initiated by the device, whether or not such device actions are automatically generated (e.g., event-driven, as determined/programmed by a user or another) or generated directly through user-actions (e.g., pressing keys, making selections, etc.).

When a device user selects/clicks and/or calls a Target(s) using a device, the click and/or call data and/or device user information (e.g., profile information, geographic information, etc.) can be transmitted to a server over one or more networks that can include a carrier network. Such collection and/or transmission of data can be facilitated by the aforementioned application resident on the device. In some embodiments, such user selection and/or other information can be additionally and/or optionally obtained from a web browser and/or another source (e.g., service provider).

Based on the device and/or user's selection/action (e.g., a telephone call, a “click” on an item/page, or another event generated by the device), referred to herein collectively as “events”, attributes a₁, a₂, a₃ . . . aₚ are generated where aᵢ (i=1 to p) represents characteristics of the device user (e.g. age, gender, economic profile of user), actions conducted by the device user (e.g., user making a call to a Target, selecting a web page), and/or events generated by the device, (e.g., the device polling for weather from server). Further, wᵢ can be understood to be a weight assigned to each attribute of the device user's information. This weight can be added to existing cumulative weights of specific elements within a matrix mₜ associated with a Target(s).

When a user selects/clicks and/or calls a Target, the resident application can transmit to the server a data set of the device user's information, and further, click and/or call data. Based on the click and/or call data of the device user, in the disclosed embodiments, a matrix mₜ is acquired from the database for the Target associated with the call data. In one embodiment, this matrix can be represented as:

$${e}_{11} … {e}_{1 p}$$

$$…$$

$${e}_{q 1} … {e}_{qp ,}$$

where p represents the number of attributes defined for a device user's information, and q represents the maximum number of categories segmenting each attribute of the device user's information. For example, an element eᵣₛ of matrix mₜ represents the weight for a category r of an attribute. A matrix mₜ for a Target can be initialized to include a set of initialization weights, and different Targets may have different initializations.

Each attribute can be subdivided into a number of categories, each of which represent a segment of values of each attribute. For example, age can be subdivided as the set of categories given by {0-15, 15-25, 25-30, 30+}, and income level can be subdivided as the set of categories given by {$0-$25,000, $25,001-$35,000, $35,000-$45,000, >$45,000}. When a device user calls and/or clicks/selects a Target, a lookup table associated with the attribute is accessed, a weight is retrieved from the lookup table, and elements within the identified Target's matrix, mₜ, are incremented using the retrieved weights. Table 1 illustrates one lookup table that includes an index, an attribute (e.g., age) having categories, and weights associated with each of the categories.

Accordingly, the device user's information can be subdivided into a number of attributes aᵢ . . . aₙ. Based on each aᵢ, a weight wᵢ can be determined using a lookup table that is associated with each attribute of each Target. For example, as Table 1 indicates, for the age attribute of a Target, e.g., ABC Pizza Restaurant, a higher weight is given to the category of age 25-35 because the pizza restaurant has shown to be more relevant to this age group than other age groups (categories). The lookup tables for Targets can be manually and/or computer-generated and/or updated.

TABLE 1

| Index | Age | Weight |
|---|---|---|
| 1 | 0-15 | 1 |
| 2 | 16-25 | 1 |
| 3 | 26-35 | 3 |
| 4 | 36+ | 2 |

In one example embodiment using Table 1, if age is the first attribute associated with a Target (i.e., in the first column of the Target's matrix mₜ) and the device user's age is 29, then the disclosed methods and systems can survey the Table 1 Age categories, determine the user as being in the 26-35 age category, and identify an index i=3 and an associated weight of 3. This weight can be combined (e.g., added) to the element in matrix mₜ where eᵢⱼ=eᵢⱼ+wᵢⱼ, and accordingly, in this example, where i=3 (e.g., third position in the lookup table above) and j=1 (age is the first attribute), e₃₁=e₃₁+3 (i.e., element e₃₁ of matrix mₜ is incremented by 3).

It can thus further be understood that each Target is associated with a matrix mₜ, a telephone number, and keywords. For example, a business “ABC Pizza” with the number 617-222-2222 and its associated matrix forms a set. This set can also be associated with keywords related to the business such as “pizza”, “pepperoni”, “pasta”, “cheese”, “restaurant”, etc. When a device user uses a keyword (e.g., a query) or information is otherwise retrieved by the device user, a “relevant” set of Targets can be identified based on a location of the device, where such location can be obtained through an input address/location and/or from the carrier network or mobile device. If the user has not input such location, a location of the device can be obtained by querying the carrier network associated with the device. If the carrier does not support location-based service (LBS), the device can be queried for its location. If the carrier supports LBS but the device does not, then the user can be asked and/or prompted to input location data.

As provided herein, a search and/or identification of Target(s) can be performed based on a Target's association with a query keyword(s) and/or information selected/input by the device user, and the distance of the Target(s) from the location of the device. The mₜ matrix for each identified Target can be obtained. Further, the device user's information can be parsed into attributes aᵢ. For each attribute aᵢ of the device user, based on the value of aᵢ, an index i can be extracted from a Target's lookup table. A value can thereafter be extracted from the Target's matrix mₜ to aid in determining the relevancy of the Target(s) to the keyword(s) and/or other information being queried by the device user. A processing scheme can be applied to the extracted elements/values eᵢ of matrix mₜ, e₁j₁, e₂j₂ . . . eₙjₙ, as extracted for each of the various attributes. This processing scheme can include, for example, a combination including a summation of some or all elements of each matrix, a product of some or all elements, and/or another processing scheme that can provide a relevancy measure based on the matrix.

For each Target(s) that was relevant to the location of the user and the keyword(s)/information being searched, a relevancy score Sₜ is computed as provided herein (e.g., extracting values from corresponding mₜ matrices). A set S can thus be sorted based on Sₜ, where the Target(s) associated with the highest score Sₜ is deemed the most relevant to the device user.

In addition to using device user characteristics (age, income, etc.) for calculating relevancy, the disclosed methods and systems also capture, collect, and/or store actions of the device user as the device user interacts with the device. For example, a device user may be presented with several value-added information sources (e.g., maps, driving directions, restaurant menu) associated with a Target search result. The corresponding click data of the device user can be used to determine relevancy of the Target(s).

Accordingly, each page link can be associated with and/or assigned a weight because some click data are more relevant than others in predicting an actual user action. For example, clicking on/selecting a page link for directions can indicate a stronger intention to visit a Target than clicking on/selecting a restaurant menu of a Target. Accordingly, given an objective to provide relevancy related to a visit of a Target, a clicking on/selection of a page link for directions should give more weight to the relevancy of a user actually visiting when compared to clicking on/selecting the restaurant menu; however, if we are capturing the relevancy associated with the event of finding the best menu of a restaurant, then the weight for the page link providing menu information will be higher than the weight assigned to other page links such as driving directions.

The resident application can thus cause a selected page's weight to be transmitted to the server with the user data and location. The weight can then be combined (e.g., added) as provided herein. It can be noted that the weights in the present instance are pre-assigned as part of the page link, and such assignment can be dynamically and/or hard coded. Accordingly, the wj in this case is equal to the weight assigned to the page link.

To be able to assign weights to a page link, a determination of the type of relevancy can be made. If it is determined that an event A provides the most relevance to the device user's search query, then weight(s) associated with a page link C1 which will cause event A to occur may be more relevant than the weight(s) associated with another page link C2 which has less of a causal relationship with event A; however, if we determine that another event E provides more relevancy than event A, then the same weight(s) associated with page link C2 may be more relevant than the same weight(s) associated with page link C1 for event E.

Although the illustrated embodiments of the disclosed methods and systems including using a matrix structure to record and/or track relevancy based on data from device users, it can be understood that the matrix can be otherwise configured, and/or other data structures can be used. Accordingly, other structures (e.g., memory elements) may record the weights as provided herein. Depending on the structure, retrieval of an index may not be necessary, for example. Accordingly, there may be various ways to index and/or access the weights and/or the categories associated with the weights.

In some embodiments, filters can be provided to the data, both in collecting and determining weights, and in providing query results. For example, based on profile and/or location information, user's may be further categorized as “locals” or “non-locals”, such that weighting may be performed different based on such status. Further, a query may be obtained based on “restaurants most popular by locals,” for example.

Auto-generated events may include auto-generated queries based on location, and/or event-based queries based on time of day, date, change in location, status, etc.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a microprocessor” and “a processor”, or “the microprocessor” and “the processor,” can be understood to include one or more microprocessors that can communicate in a stand-alone and/or a distributed environment(s), and can thus can be configured to communicate via wired or wireless communications with other processors, where such one or more processor can be configured to operate on one or more processor-controlled devices that can be similar or different devices. Use of such “microprocessor” or “processor” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet. References herein to microprocessor instructions or microprocessor-executable instructions, in accordance with the above, can be understood to include programmable hardware.

Unless otherwise stated, use of the word “substantially” can be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun can be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, can be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, can be made by those skilled in the art. Accordingly, it will be understood that the disclosed methods and systems are not to be limited to the embodiments disclosed herein, can include practices otherwise than specifically described, and are to be interpreted as broadly as allowed under the law.

What is claimed is:

1. A process and system comprising:
A server collecting click data and call data from a client software or any networked server and storing the data into a database.
The process and method of storing and assigning weight(s) to the Target(s) based on the Device user's information. The Target(s) can be a location(s), a business(es), a person(s) or a website(s) that is the recipient of the call or click from the Device user.
The process and method of sorting and determining relevancy of Target(s) based on weight(s), location and profile of the Device user, and/or keywords or information searched.
The user interface and presentation layer to display and inform the Device users of the relevant search results.

2. A client software on the Device transmitting click data and call data to a server over a telephony, cellular, VoIP, or Internet network (the Network).

3. A client software of claim 2, in which the act of calling or clicking to a Target(s) on the Device transmits the Device user's and/or Target(s)' information to known server.

4. A computer-implemented method of claim 1, in which
a) A target is associated with a matrix m where each element of m is initialized with different weights k.
b) Each element in matrix m associated with the target is increased by a unique set of weights W where w₁, w₂ . . . wₙ of W depends on the click or call data received
c) The matrix m associated with the target is used to compute the target relevancy score s.
d) A set of scores S of matrices m are sorted based on a sorting algorithm.

5. A computer-implemented method of claim 4, wherein step (a) comprised of either a human manual method and/or a computer-implemented method of determining the initial weights of the matrices associated with the Target(s).

6. The method of claim 4, wherein step (b) comprised of the matrix m whose structure is defined by a set of attributes and categories.

7. The method of claim 6, where categories further segment each attribute.

8. The computer-implemented method of claim 1, in which the weight(s), wᵢ, is computed based on a algorithm A1 where the input(s) is the Device user's and/or Target(s)' information.

9. The computer-implemented method of claim 1, in which the location of the Device user and/or the keywords and/or information being searched is sent to the server in order to acquire a set of matrices M associated with Target(s)

10. The computer-implemented method of claim 1, in which an algorithm A2 is applied to the matrices M comprising of matrices m₁, m₂ . . . mₙ to compute relevancy scores S comprising of score results s₁, s₂ . . . sₙ

11. The computer-implemented method of claim 1, in which a sorting algorithm Aₛₒᵣₜ is applied to the relevancy scores S, computed in claim 10, to determine the relevancy/ranking order of Target(s).

12. The computer-implemented method of claim 1, in which the Target(s) are presented on the Device in the order that was sorted as described in claim 11.

13. The computer-implemented method of claim 1, in which Device user's information is used to increase the relevancy of Target(s) to other future Device users using the service.

14. The computer-implemented method of claim 1, in which Device user's information is used to acquire the most relevant Target(s) pertaining to the Device user.

15. The computer-implemented method of claim 1, in which actions and events generated by Device User and Device are assigned different weights depending on the relevancy to events associated with it,
